(19) United States
(12) Patent Application Publication
(10) Pub. No.: US 2007/0027891 A1
(43) Pub. Date: Feb. 1, 2007

(54) System and method for providing listing check functionality

(76) Inventors: Christiane Schauerte, Heidelberg (DE); Mathias Knura, Speyer (DE); Norbert Heberle, Wiesloch (DE); Christiane Kuntz-Mayr, Limburgerhof (DE)

Correspondence Address: KENYON & KENYON LLP, 1500 K STREET N.W., WASHINGTON, DC, 20005, US

(21) Appl. No.: 11/193,403

(22) Filed: Aug. 1, 2005

(51) Int. Cl. G06F 7/00

(52) U.S. Cl. 707/101

(57) ABSTRACT

A system and method for providing listing check functionality. According to particular embodiments of the invention, an application program searches for and accesses a listing rule to determine whether a product is prohibited by a business organization from being purchased, or allowed by the business organization to be purchased. The listing rule is embodied in a first data structure including one or more pre-configured data elements identifying a classification of the business organization associated, and a link, and a second data structure referenced by the link, the second data structure including or referencing one or more data elements identifying a classification of the product, wherein at least the first data structure or the second data structure includes one or more user-defined data elements identifying either a classification of the business organization or the product, and one or more data elements identifying a listing condition associated with the listing rule.

### BACKGROUND OF THE INVENTION

In general commercial relationships, large organizations often set limits on the purchasing power of individual units within the organization. For example, a retailer may indicate to a consumer products manufacturer that its retail stores may not order certain goods from the manufacturer. Alternatively, the retailer may specify that its retail stores may only order certain goods. Sometimes the retailer may specify that any order that does not meet these specifications may not be accepted.

Consumer products manufacturers may use automated ordering systems to support their efforts. These ordering systems check newly received orders from purchasers to determine if the associated order items are allowed or prohibited. For each purchaser (e.g., retailer) or purchasing organization (e.g., retail organization), the ordering system may include “listings,” a data set that specifies the requirements all orders must meet—either by inclusion or by exclusion of specified products.

The ordering systems can be quite complex. SAP AG, for example, provides automated ordering functionality in both its ERP Sales and Distribution application (hereinafter “SD application”) and its CRM Enterprise and Mobile Client application (hereinafter “EMC application”). Each application, therefore, includes an independent listing rule set that defines, for each purchaser, requirements that the orders must meet. The listing rule sets of each application have unique formats and unique search algorithms.

For example, in SAP's SD application, the listing rule set is formatted into flat records (i.e., unitary data structures with no linkages to other data structures), so that the listing data may be directly accessed by a search in one step without further evaluation. Accordingly, every listing record is defined for only one product. Thus, if multiple products are listed for a particular purchaser, then multiple listing records are defined for the purchaser—one for each product. Additionally, any standard data element in the SD application which is pre-configured at the development level, and moreover any custom data element which is defined by the user at the application level, can be used to create such listing records (e.g., classifications such as customer sales group or sales district, customer region or country, product group, product brand). By this, listings can be flexibly created according to a customer's needs. As used herein, data elements pertain to logical units of data, whereas fields pertain to actual storage units and data items pertain to individual instances of data elements.

On the other hand, in SAP's EMC application, the listing rule set is formatted into non-flat, or relational, records so that it is possible to associate various products with various purchasers within one associated data set. Under this format, multiple products and purchasers are referenced at the same level by a header element. However, not only is this format not fitting for quick searches for allowed/prohibited products for a particular purchaser, it also only allows a pre-configured standard set of attributes to be used for defining listings, such as product, product category, product catalog, business partner, business partner hierarchy, and target group.

Accordingly, there is a need in the art for a system and method that integrates the benefits of different existing types of listing rule sets so that a consistent and efficient listing functionality may be provided over a complete system landscape.

### BRIEF DESCRIPTION OF THE DRAWINGS

FIG. 1 is a block diagram that depicts data structures associated with listing rules in accordance with an embodiment of the present invention.

FIG. 2 is a block diagram that depicts a system architecture in accordance with an embodiment of the present invention.

FIG. 3 is a process flow diagram that depicts a listing check process between a client and a server in accordance with an embodiment of the present invention.

FIG. 4 is a flow chart that depicts a listing check process for prohibited items in accordance with an embodiment of the present invention.

FIG. 5 is a flow chart that depicts a listing check process for allowed items in accordance with an embodiment of the present invention.

FIG. 6 is a block diagram that depicts a computing device in accordance with an embodiment of the present invention.

### DETAILED DESCRIPTION

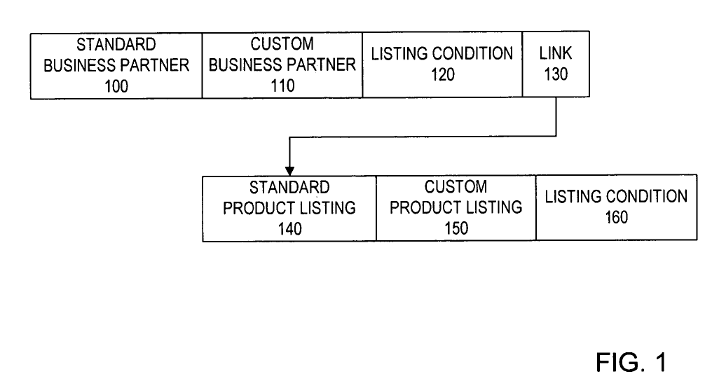

The present invention addresses the current drawbacks in listing check functionality by implementing a data model that combines the flexibility and efficiency of a flat record model with the product bundling ability of a relational model, as illustrated in FIG. 1.

FIG. 1 depicts data structures that may be utilized in the implementation of a listing check in accordance with an embodiment of the present invention. For instance, for identifying classifications of a business organization associated with a listing, a data structure may include one (100) or more data elements that are pre-configured at the development level in addition to one (110) or more data elements that are defined by the application user at the application level. The data structure may also include one (120) or more data elements identifying listing conditions, which may, for example, specify requirements to be met to validate the listing (such as a time period). And finally, the data structure may include a link (130) to another data structure that contains or references the product information.

For identifying classifications of any product associated with the listing, the other data structure may similarly include one (140) or more data elements that are pre-configured at the development level in addition to one (150) or more data elements that are defined by the application user at the application level. This other data structure may also include one (160) or more data elements identifying listing conditions for the associated product. Of course, in other embodiments the user-defined data elements and/or the listing condition data elements may reside only in one of the data structures.

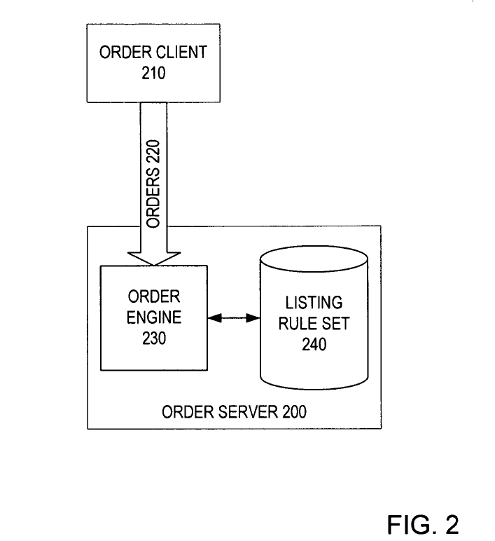

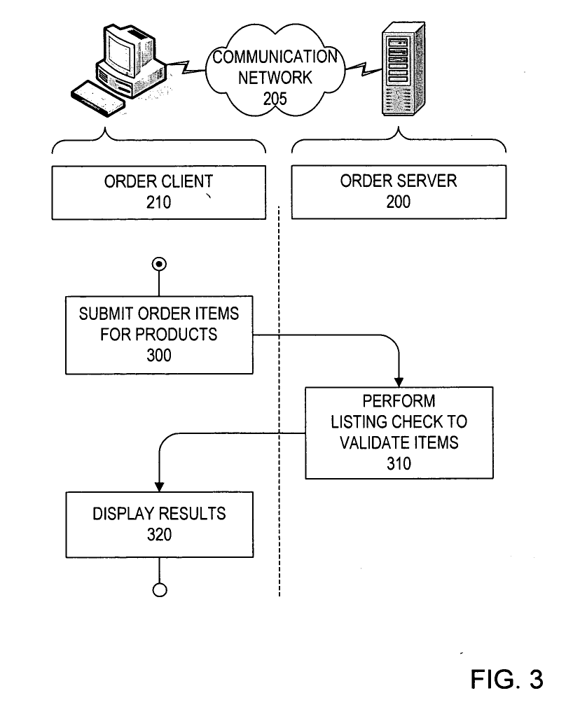

FIGS. 2 and 3 depict a system architecture and accompanying listing check process, respectively, in accordance with an embodiment of the present invention. In this embodiment, a purchaser using a client application (210) of an order system submits order items (220) over a network (205) to a server (200) in order to validate the purchase of the items (step 300). Upon receiving the order items (220) at the server (200), the order engine (230) accesses a listing rule set database (240) to determine whether the purchase of any item is allowed or prohibited (step 310). Upon making this determination, the server (200) provides the results to the client application (210) for display to the purchaser (step 320).

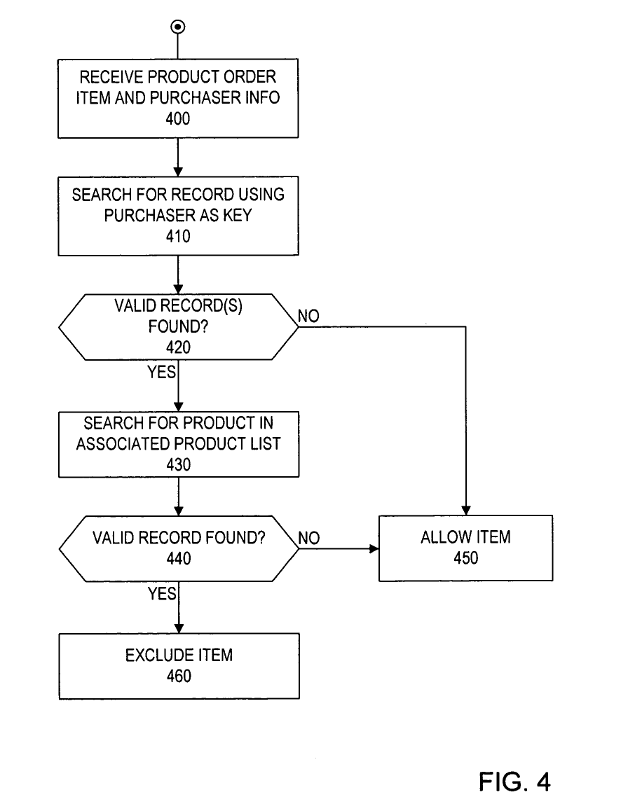

FIG. 4 depicts a listing check process that could be implemented by the order engine (230) in step 310 to determine if an order item is specifically prohibited from purchase in accordance with an embodiment of the present invention. Upon receiving the product order item and purchaser identification information (step 400), the order engine (230) searches a listing rule set database (240) for any records using the purchaser identification information as a key (step 410). The purchaser identification information may be represented in one (100) or more of the pre-configured business partner data elements or one (110) or more of the user-defined business partner data elements. If no valid records are found (step 420), the order engine (230) allows the item to be purchased (step 450) because no valid listing exists identifying the item as excluded. (In this embodiment, a valid record is one in which an associated listing condition (120) is satisfied, such as a time period).

If, on the other hand, the search returns one or more valid records (step 420), then for each identified record the order engine (230) follows the link (130) to search the product list contained in a different record (step 430). If no valid records are found (step 440), the order engine (230) allows the item to be purchased (step 450) because no valid listing exists identifying the item as excluded. If, on the other hand, the search returns a valid record (step 440), then the order engine (230) prohibits the purchase of the item because the item has been specifically identified as excluded (460).

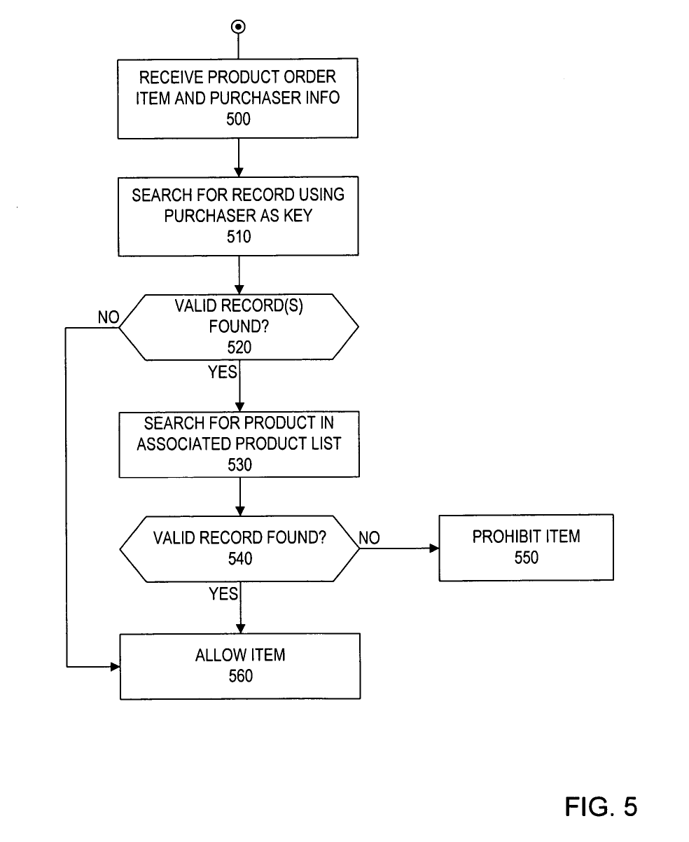

FIG. 5 depicts a listing check process that could be implemented by the order engine (230) in step 310 to determine if an order item is specifically allowed for purchase in accordance with an embodiment of the present invention. Upon receiving the product order item and purchaser identification information (step 500), the order engine (230) searches a listing rule set database (240) for any records using the purchaser identification information as a key (step 510). The purchaser identification information may be represented one (100) or more of the pre-configured business partner data elements or one (110) or more of the user-defined business partner data elements. If no valid records are found (step 520), the order engine (230) allows the item to be purchased (step 560) because no valid listing of specifically allowable items exists in which the item was absent. (In this embodiment also, a valid record is one in which an associated listing condition (120) is satisfied, such as a time period).

If, on the other hand, the search returns one or more valid records (step 520), then for each identified record the order engine (230) follows the link (130) to search the product list contained in a different record (step 530). If no valid records are found (step 540), the order engine (230) prohibits the item from being purchased (step 550) because a valid listing of specifically allowable items exists in which the item was absent. If, on the other hand, the search returns a valid record (step 540), then the order engine (230) allows the purchase of the item because the item has been specifically identified as allowable (560).

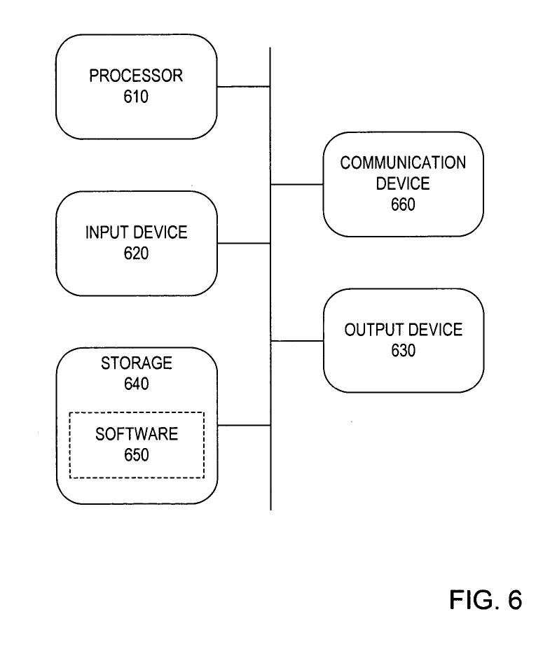

FIG. 6 illustrates the components of a basic computing device in accordance with an embodiment of the present invention, which may include order client 210 and order server 200. The computing device may be a personal computer, workstation, handheld personal digital assistant (“PDA”), server, or any other type of microprocessor-based device. The computing device may include one or more of processor 610, input device 620, output device 630, storage 640, and communication device 660.

Input device 620 may include a keyboard, mouse, pen-operated touch screen or monitor, voice-recognition device, or any other device that provides input. Output device 630 may include a monitor, printer, disk drive, speakers, or any other device that provides output.

Storage 640 may include volatile and nonvolatile data storage, including one or more electrical, magnetic or optical memories such as a RAM, cache, hard drive, CD-ROM drive, tape drive or removable storage disk. Communication device 660 may include a modem, network interface card, or any other device capable of transmitting and receiving signals over a network. The components of the computing device may be connected in any manner, such as via electrical bus or wirelessly.

Software 650, which may be stored in storage 640 and executed by processor 610, may include, for example, the application programming that embodies the functionality of the present invention (e.g., as embodied in order engine 230). Software 650 may include a combination of enterprise servers such as an application server and a database server.

Communication network 205 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 650 may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention. For example, software modules that implement the present invention such as order engine 230 may comprise several discrete modules that together still provide the same functionality, data specified in listing rule set 240 may be spread over several databases and/or systems, and the flow diagrams of FIGS. 3, 4 and 5 may encompass several intermediate steps that do not detract from the higher level functionality described therein. Also, in another embodiment a listing check may enable a purchasing organization to mandate the purchase of certain products by a purchaser.

What is claimed is:

1. A memory for storing data structures to be accessed by an application program being executed on a computer, the data structures comprising:
a first data structure including:
one or more pre-configured data elements identifying a classification of a business organization associated with a listing, and
a link; and
a second data structure referenced by the link, the second data structure including or referencing:
one or more data elements identifying a classification of a product associated with the listing;
wherein at least the first data structure or the second data structure includes:
one or more user-defined data elements identifying either a classification of the business organization or the product, and
one or more data elements identifying a listing condition associated with the listing.

2. The memory of claim 1, wherein the listing condition specifies a requirement to be met to validate the listing.

3. The memory of claim 2, wherein the requirement is a time period.

4. The memory of claim 1, wherein the listing identifies one or more products allowed to be purchased by the business organization.

5. The memory of claim 1, wherein the listing identifies one or more products prohibited from being purchased by the business organization.

6. The memory of claim 1, wherein the first data structure and the second data structure are database tables.

7. The memory of claim 1, wherein the one or more user-defined data elements include a customer sales group.

8. The memory of claim 1, wherein the one or more user-defined data elements include a customer sales district.

9. The memory of claim 1, wherein the one or more user-defined data elements include a product brand.

10. A computer-implemented method for providing listing check functionality, comprising:
receiving a listing check request identifying a business organization and a product;
searching a listing rule set to identify a listing rule associated with the business organization; and
accessing the identified listing rule to determine whether the product is prohibited from being purchased by the business organization;
wherein the identified listing rule is embodied in:
a first data structure including:
one or more pre-configured data elements identifying a classification of the business organization, and
a link; and
a second data structure referenced by the link, the second data structure including or referencing:
one or more data elements identifying a classification of the product;
wherein at least the first data structure or the second data structure includes:
one or more user-defined data elements identifying either a classification of the business organization or the product, and
one or more data elements identifying a listing condition associated with the identified listing rule.

11. The method of claim 10, wherein the determination of whether the product is prohibited from being purchased by the business organization is based at least in part on the listing condition.

12. The method of claim 11, wherein the listing condition specifies a requirement to be met to validate the listing.

13. The method of claim 12, wherein the requirement is a time period.

14. The method of claim 10, wherein the first data structure and the second data structure are database tables.

15. A computer-implemented method for providing listing check functionality, comprising:
receiving a listing check request identifying a business organization and a product;
searching a listing rule set to identify a listing rule associated with the business organization; and
accessing the identified listing rule to determine whether the product is allowed to be purchased by the business organization;
wherein the identified listing rule is embodied in:
a first data structure including:
one or more pre-configured data elements identifying a classification of the business organization, and
a link; and
a second data structure referenced by the link, the second data structure including or referencing:
one or more data elements identifying a classification of the product;
wherein at least the first data structure or the second data structure includes:
one or more user-defined data elements identifying either a classification of the business organization or the product, and
one or more data elements identifying a listing condition associated with the identified listing rule.

16. The method of claim 15, wherein the determination of whether the product is allowed to be purchased by the business organization is based at least in part on the listing condition.

17. The method of claim 16, wherein the listing condition specifies a requirement to be met to validate the listing.

18. The method of claim 17, wherein the requirement is a time period.

19. The method of claim 15, wherein the first data structure and the second data structure are database tables.
